(19) United States
(12) Patent Application Publication
(10) Pub. No.: US 2004/0234874 A1
(43) Pub. Date: Nov. 25, 2004

(54) Cylindrical electrophotographic photoreceptor, and electrophotographic apparatus

(76) Inventor: Takahito Miyamoto, Nagano (JP)

Correspondence Address: RABIN & Berdo, PC, 1101 14TH STREET, NW, SUITE 500, WASHINGTON, DC, 20005, US

(21) Appl. No.: 10/792,298

(22) Filed: Mar. 4, 2004

(30) Foreign Application Priority Data
Mar. 17, 2003 (JP) 2003-072122

(51) Int. Cl. G03G 5/047

(52) U.S. Cl. 430/58.05; 399/159

(57) ABSTRACT

An electrophotographic apparatus including a cylindrical layered electrophotographic photoreceptor. Electrophotographic processing components are disposed in the vicinity of a peripheral surface of the photoreceptor. The apparatus forms images by operating the processing components while rotating the photoreceptor. The following relationships expressions (1) and (2) exist among the peripheral speed V in mm/sec of the photoreceptor, the contact angle A in degrees of the surface of the photoreceptor to pure water, and the thickness T in μm of a charge transport layer of the photoreceptor:

V^{0.1}×A×T^{0.2}<270 (1)

T>25 (2).

### BACKGROUND OF THE INVENTION

1. Field of the Invention

The invention relates to an electrophotographic apparatus that has a cylindrical electrophotographic photoreceptor having a layered photosensitive layer formed on an outer peripheral surface thereof. The invention enables good image formation to be carried out at high speed, and also relates to the cylindrical electrophotographic photoreceptor used in such an apparatus.

2. Description of the Related Art

With regard to hardware, electrophotography using the Carlson process first achieved development in the field of copiers, and has recently expanded into fields such as laser printers, fax machines, and digital composite machines. Moreover, with regard to environmental friendliness, product quality, price, efficiency and so on, there currently are calls for ease of disposal, ease of collection, increased image quality, increased lifetime through high printing resistance, increased speed, and so on.

With an electrophotographic photoreceptor in which a photosensitive layer (photoconductive layer) is provided on the outer surface of a cylindrical electrically conductive substrate, recently it has become the norm to use an aluminum alloy as the electrically conductive substrate, and to use a photosensitive layer having as a principal component thereof an organic material instead of a conventional selenium alloy.

Regarding the layer structure of the photosensitive layer, it is common to use a layered photoreceptor comprising a plurality of layers separated by function. The reason for this is that a layered photoreceptor has stable photoreceptor properties, and it is easy effectively to bring out the properties of the functional material of each layer and hence to improve the properties. For example, commonly used as such a layered photoreceptor is one in which the functions are separated into an undercoat layer for suppressing unwanted injection of charge into the photosensitive layer from the substrate, a charge generation layer that generates charge pairs upon exposure to light, a charge transport layer that transports the injected charge to the surface and so on.

In general both improved image quality and improved lifetime are demanded for a layered photoreceptor as described above. The improvement in image quality is evaluated in terms of the resolution, ghosting, fogging and so on. In particular, regarding the resolution, there is a strong trend toward color, and hence a resolution of at least 1200 dpi is strongly demanded. To meet the demands for an increased lifetime of photoreceptors, ozone resistance and resistance to light fatigue are required.

Another particularly important measure for such improvement is increasing the printing wear resistance of the photosensitive layer. The resistance of the photosensitive layer to printing wear is determined by the percentage content of the binder resin in the charge transport layer, which is the uppermost layer among the layers comprising the photosensitive layer, and also by the resistance to printing wear of the binder resin itself. Thus, increasing the percentage content of the binder resin and/or increasing the molecular weight of the binder resin are effective.

However, the most reliable method is to increase the thickness of the charge transport layer, which can easily be implemented merely by changing the application conditions. However, increasing the resolution and increasing the thickness of the charge transport layer are conflicting things. In particular, if the thickness of the charge transport layer exceeds 25 μm, it becomes difficult to achieve a photoreceptor having a resolution of at least 1200 dpi.

Japanese Patent Application Laid-open No.8-240925 discloses a layered photoreceptor in an image forming apparatus, having a charge transport layer with increased thickness of up to 25 μm, and for which the image density is high, and a sharp image can be obtained even with a small spot latent image. Furthermore, there are also disclosures in Japanese Patent Application Laid-open No. 8-240925 regarding the peripheral speed of the photoreceptor, and the contact angle of the surface of the photoreceptor to pure water (paragraphs 0023, 0137 to 0225).

However, an increase in the thickness of the charge transport layer is accompanied by an increase in the charge transport distance from the charge generation layer to the surface of the injected charge. Moreover, the size of the diffusion component in a direction parallel to the injected charge surface also increases. Hence, the charge density of the charge reaching that surface drops. As a result, there is an unavoidable drawback of a drop in the ability of the apparatus to create dot formation (resolution). The greater the thickness, the greater the problem. Thus, as mentioned earlier, there is a conflict between producing good resolution and increasing the thickness of the charge transport layer.

To improve the ability to provide good dot formation (resolution), it is effective to use a charge generation material having high sensitivity and a charge transport material having high mobility. However, in this case, a separate drawback is brought about in that toner excessively attaches to the developing part, and hence the consumption of toner increases and the void fine line formation ability drops.

With the apparatus disclosed in Japanese Patent Application Laid-open No. 8-240925, the problems described above are not resolved and a photoreceptor is obtained that exhibits a good resolution of at least 1200 dpi even if the thickness of the charge transport layer is made large. Therefore, Japanese Patent Application Laid-open No. 8-240925 provides no suggestions whatsoever regarding a solution of the problems arising in the case of trying to make the thickness of the charge transport layer large, in particular exceeding 25 μm.

### SUMMARY OF THE INVENTION

In view of the above, it is an object of the invention to provide an electrophotographic apparatus according to which images of high resolution of at least 1200 dpi can be obtained with high resistance to printing wear even if a photoreceptor having a charge transport layer with a thickness exceeding 25 μm is installed in the electrophotographic apparatus. Another object of the invention is to provide a cylindrical electrophotographic photoreceptor used in such an apparatus.

According to the invention, the above object is attained with an electrophotographic apparatus having a resolution of at least 1200 dpi, which comprises a cylindrical electrophotographic photoreceptor having a charge generation layer and a charge transport layer, and electrophotographic processing components that are disposed in the vicinity of a peripheral surface of the photoreceptor, and forms images by operating the processing components while rotating the photoreceptor. According to the invention, the following relationships hold among the peripheral speed V in mm/sec of the photoreceptor, the contact angle A in degrees of the surface of the photoreceptor to pure water, and the thickness T in μm of the charge transport layer of the photoreceptor.

V^{0.1}×A×T^{0.2}<270 (1)

T>25 (2)

According to another aspect of invention of a cylindrical electrophotographic photoreceptor as described above is provided, which can be installed to provide the above electrophotographic apparatus.

### BRIEF DESCRIPTION OF THE DRAWINGS

FIG. 1 is a schematic view of the constitution of an electrophotographic apparatus according to the invention; and

FIG. 2 is a schematic sectional view of an electrophotographic photoreceptor according to the invention.

### DESCRIPTION OF THE PREFERRED EMBODIMENTS

Following is a detailed description, with reference to the drawings, of the electrophotographic apparatus according to the invention and the cylindrical electrophotographic photoreceptor for installation in this apparatus. The invention is not limited to the examples described below, so long as the gist of the invention is not transcended.

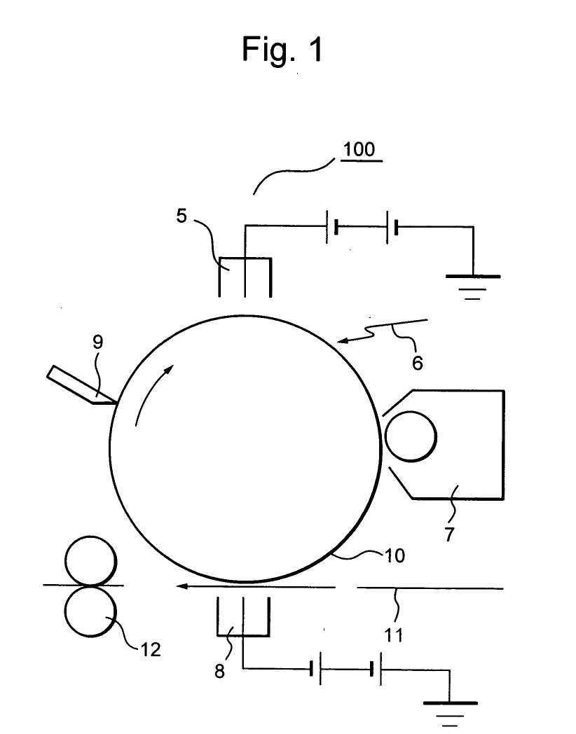

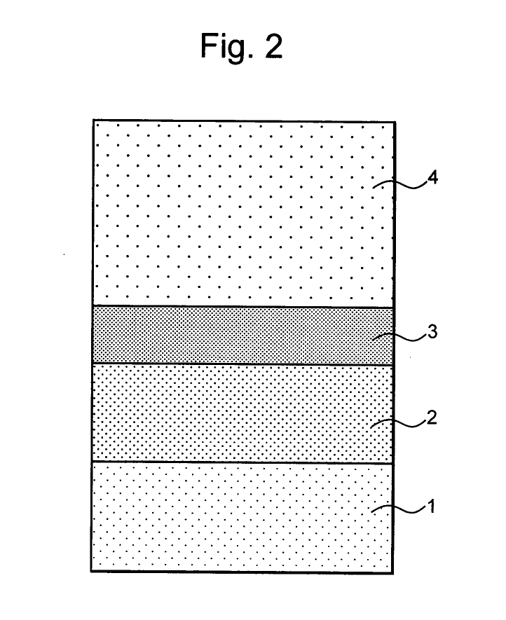

FIG. 1 is a schematic view of the constitution of an electrophotographic apparatus according to the invention, and FIG. 2 is a schematic sectional view of a cylindrical electrophotographic photoreceptor installed in this electrophotographic apparatus. In the electrophotographic apparatus 100 according to the invention, a charging device 5, an exposing device 6, a developing device 7, a transferring device 8, a cleaning device 9 and so on are provided as required around the outer periphery of a cylindrical electrophotographic photoreceptor 10, and printing paper 11 onto which developed images are transferred is outputted via a fixing device 12.

In the cylindrical electrophotographic photoreceptor 10 according to the invention, an undercoat layer 2, a charge generation layer 3 and a charge transport layer 4 are formed in this order on the outer surface of an electrically conductive cylindrical substrate 1 made of an aluminum alloy or the like. There are no particular limitations on the materials used in the cylindrical electrophotographic photoreceptor according to the invention. Thus, the cylindrical electrophotographic photoreceptor may be manufactured using publicly known materials and a publicly known manufacturing method.

### EXAMPLES

Following are descriptions, showing how exemplary photoreceptors according to the invention give image properties better than those of conventional photoreceptors. Examples 1 to 12 show image evaluations for the case of using a photoreceptor having a charge transport layer of conventionally ordinary thickness (outside the range of the invention). In all of Examples 1 to 12, the thickness of the charge transport layer is not more than 25 μm, and hence the printing wear resistance is worse than with a photoreceptor according to the invention; nevertheless, if only the image properties are focussed upon, then there are many good examples with these conventional photoreceptors. In Examples 13 to 16, overall the resolution evaluation shows a severe situation, but out of these examples, the photoreceptors and electrophotographic apparatuses satisfying the conditions according to the invention exhibit superior image properties. By contrast, the photoreceptors not satisfying these conditions exhibit poor image properties. Regarding the printing wear resistance, under the same conditions, the printing wear resistance will simply be proportional to the thickness of the charge transport layer. Hence a thickness exceeding 25 μm will give better printing wear resistance than a thickness of 25 μm or less; thus evaluation of printing wear per se has not been carried out.

### Example 1

Using cut JIS-A6000 type aluminum pipe of diameter 30 mm as a substrate, the pipe was washed using an alkaline detergent, and then a coating film was formed on the outer peripheral surface of the pipe by immersion in a coating liquid obtained by dispersing/dissolving a vinylphenol resin, a butylated melamine resin and titanium oxide in a solvent. The coating film then was dried by heat to form an undercoat layer. A coating film was then formed on top of the undercoat layer by immersion in a coating liquid obtained by dispersing/dissolving a polyvinyl butyral resin and an α-type phthalocyanine in a solvent. The coating film then was dried by heat to form a charge generation layer. A coating film was then formed on top of the charge generation layer by immersion in a coating liquid obtained by dissolving a styryl-type electrically conductive material, a copolymer resin between a siloxane and a polycarbonate resin, and an antioxidant in a solvent. Then the coating film was dried by heat to form a charge transport layer.

The thickness of the charge transport layer was made thin at 15 μm. The content of the siloxane was varied, thus manufacturing cylindrical electrophotographic photoreceptors having four different values of the surface contact angle of the charge transport layer to pure water, 80, 85, 90 and 95°. These cylindrical electrophotographic photoreceptors were taken as evaluation samples.

Each of the cylindrical electrophotographic photoreceptors was installed in a printing evaluation apparatus (LP series (resolution 1200 dpi) made by Epson) having a peripheral speed of 45 mm/sec. An evaluation of the 1-dot formation ability (resolution) was carried out. Evaluation results were classified among five evaluation levels (with 1 being poor, 5 being good, and 2, 3 and 4 in this order being intermediate evaluation results) Also, an evaluation was performed of the 2-dot void fine line formation ability (resolution) (results again being classified into five evaluation levels as above). The evaluation results are shown in Table 1 (in the 5-level evaluation, 4 or above being acceptable in terms of practical application).

TABLE 1

| | | | 2-dot void fine |
|---|---|---|---|
| Contact | Value of left side | 1-dot formation | line formation |
| angle A (°) | of equation (1) | ability | ability |
| 80 | 201 | 5 | 5 |
| 85 | 214 | 5 | 5 |
| 90 | 226 | 5 | 5 |
| 95 | 239 | 5 | 5 |

### Example 2

Evaluation was carried out as in Example 1, except that the peripheral speed of the printing evaluation apparatus was changed to 68 mm/sec. The evaluation results are shown in Table 2.

TABLE 2

| | | | 2-dot void fine |
|---|---|---|---|
| Contact | Value of left side | 1-dot formation | line formation |
| angle A (°) | of equation (1) | ability | ability |
| 80 | 210 | 5 | 5 |
| 85 | 223 | 5 | 5 |
| 90 | 236 | 5 | 5 |
| 95 | 249 | 5 | 5 |

### Example 3

Evaluation was carried out as in Example 1, except that the peripheral speed of the printing evaluation apparatus was changed to 92 mm/sec. The evaluation results are shown in Table 3.

TABLE 3

| | | | 2-dot void fine |
|---|---|---|---|
| Contact | Value of left side | 1-dot formation | line formation |
| angle A (°) | of equation (1) | ability | ability |
| 80 | 216 | 5 | 5 |
| 85 | 230 | 5 | 5 |
| 90 | 243 | 5 | 5 |
| 95 | 257 | 4 | 5 |

### Example 4

Evaluation was carried out as in Example 1, except that the peripheral speed of the printing evaluation apparatus was changed to 114 mm/sec. The evaluation results are shown in Table 4.

TABLE 4

| | | | 2-dot void fine |
|---|---|---|---|
| Contact | Value of left side | 1-dot formation | line formation |
| angle A (°) | of equation (1) | ability | ability |
| 80 | 221 | 5 | 5 |
| 85 | 235 | 5 | 5 |
| 90 | 248 | 4 | 5 |
| 95 | 262 | 4 | 4 |

From Tables 1 to 4, it can be seen that with the thickness of the charge transport layer being low at 15 μm, the left side of equation (1) is less than 270, and the 1200 dpi resolution is good. Because the thickness of the charge transport layer is low at 15 μm, this shows that there are originally no problems with a resolution of 1200 dpi.

### Example 5

Evaluation samples of cylindrical layered photoreceptors having four different values of the contact angle were manufactured as in Example 1, except that the thickness of the charge transport layer was changed to 20 μm, and evaluation was carried out as in Example 1. The evaluation results are shown in Table 5.

TABLE 5

| | | | 2-dot void fine |
|---|---|---|---|
| Contact | Value of left side | 1-dot formation | line formation |
| angle A (°) | of equation (1) | ability | ability |
| 80 | 213 | 5 | 5 |
| 85 | 226 | 5 | 5 |
| 90 | 240 | 5 | 5 |
| 95 | 253 | 4 | 5 |

### Example 6

Evaluation was carried out as in Example 5, except that the peripheral speed of the printing evaluation apparatus was changed to 68 mm/sec. The evaluation results are shown in Table 6.

TABLE 6

| | | | 2-dot void fine |
|---|---|---|---|
| Contact | Value of left side | 1-dot formation | line formation |
| angle A (°) | of equation (1) | ability | ability |
| 80 | 222 | 5 | 5 |
| 85 | 236 | 5 | 5 |
| 90 | 250 | 4 | 5 |
| 95 | 264 | 4 | 4 |

### Example 7

Evaluation was carried out as in Example 5, except that the peripheral speed of the printing evaluation apparatus was changed to 92 mm/sec. The evaluation results are shown in Table 7.

TABLE 7

| | | | 2-dot void fine |
|---|---|---|---|
| Contact | Value of left side | 1-dot formation | line formation |
| angle A (°) | of equation (1) | ability | ability |
| 80 | 229 | 5 | 5 |
| 85 | 243 | 5 | 5 |
| 90 | 258 | 4 | 5 |
| 95 | 272 | 3 | 4 |

### Example 8

Evaluation was carried out as in Example 5, except that the peripheral speed of the printing evaluation apparatus was changed to 114 mm/sec. The evaluation results are shown in Table 8.

TABLE 8

| | | | 2-dot void fine |
|---|---|---|---|
| Contact | Value of left side | 1-dot formation | line formation |
| angle A (°) | of equation (1) | ability | ability |
| 80 | 234 | 5 | 5 |
| 85 | 248 | 5 | 5 |
| 90 | 263 | 3 | 4 |
| 95 | 278 | 2 | 4 |

From Tables 5 to 8, it can be seen that in the case that the charge transport layer thickness is 20 μm, there are no problems with usage with a resolution of 1200 dpi if the contact angle of the charge transport layer is held below 90° and the peripheral speed of the drum is below 92 mm/sec.

### Example 9

Evaluation samples of cylindrical layered photoreceptors having four different values of the contact angle were manufactured as in Example 1, except that the thickness of the charge transport layer was raised to 25 μm, and an evaluation was carried out as in Example 1. The evaluation results are shown in Table 9.

TABLE 9

| | | | 2-dot void fine |
|---|---|---|---|
| Contact | Value of left side | 1-dot formation | line formation |
| angle A (°) | of equation (1) | ability | ability |
| 80 | 223 | 5 | 5 |
| 85 | 237 | 5 | 5 |
| 90 | 251 | 4 | 5 |
| 95 | 265 | 4 | 4 |

### Example 10

Evaluation was carried out as in Example 9, except that the peripheral speed of the printing evaluation apparatus was changed to 68 mm/sec. The evaluation results are shown in Table 10.

TABLE 10

| | | | 2-dot void fine |
|---|---|---|---|
| Contact | Value of left side | 1-dot formation | line formation |
| angle A (°) | of equation (1) | ability | ability |
| 80 | 232 | 5 | 5 |
| 85 | 247 | 5 | 5 |
| 90 | 261 | 4 | 4 |
| 95 | 276 | 3 | 4 |

### Example 11

Evaluation was carried out as in Example 9, except that the peripheral speed of the printing evaluation apparatus was changed to 92 mm/sec. The evaluation results are shown in Table 11.

TABLE 11

| | | | 2-dot void fine |
|---|---|---|---|
| Contact | Value of left side | 1-dot formation | line formation |
| angle A (°) | of equation (1) | ability | ability |
| 80 | 239 | 5 | 5 |
| 85 | 254 | 5 | 5 |
| 90 | 269 | 4 | 4 |
| 95 | 284 | 3 | 4 |

### Example 12

Evaluation was carried out as in Example 9, except that the peripheral speed of the printing evaluation apparatus was changed to 114 mm/sec. The evaluation results are shown in Table 12.

TABLE 12

| | | | 2-dot void fine |
|---|---|---|---|
| Contact | Value of left side | 1-dot formation | line formation |
| angle A (°) | of equation (1) | ability | ability |
| 80 | 245 | 5 | 5 |
| 85 | 260 | 4 | 4 |
| 90 | 275 | 3 | 4 |
| 95 | 290 | 2 | 3 |

From Tables 9 to 12, it can be seen that in the case that the thickness of the charge transport layer is 25 μm, there are no problems with usage with a resolution of 1200 dpi if the charge transport layer is made of such a material that the contact angle thereof is 85° or less.

### Example 13

Evaluation samples of cylindrical layered photoreceptors having four different values of the contact angle were manufactured as in Example 1, except that the thickness of the charge transport layer was changed to 30 μm. Evaluation was carried out as in Example 1. The evaluation results are shown in Table 13.

TABLE 13

| | | | 2-dot void fine |
|---|---|---|---|
| Contact | Value of left side | 1-dot formation | line formation |
| angle A (°) | of equation (1) | ability | ability |
| 80 | 231 | 5 | 5 |
| 85 | 246 | 5 | 5 |
| 90 | 260 | 4 | 4 |
| 95 | 274 | 3 | 4 |

### Example 14

Evaluation was carried out as in Example 13, except that the peripheral speed of the printing evaluation apparatus was changed to 68 mm/sec. The evaluation results are shown in Table 14.

TABLE 14

| | | | 2-dot void fine |
|---|---|---|---|
| Contact | Value of left side | 1-dot formation | line formation |
| angle A (°) | of equation (1) | ability | ability |
| 80 | 241 | 5 | 5 |
| 85 | 256 | 4 | 5 |
| 90 | 261 | 4 | 4 |
| 95 | 271 | 3 | 4 |

### Example 15

Evaluation was carried out as in Example 13, except that the peripheral speed of the printing evaluation apparatus was changed to 92 mm/sec. The evaluation results are shown in Table 15.

TABLE 15

| | | | 2-dot void fine |
|---|---|---|---|
| Contact | Value of left side | 1-dot formation | line formation |
| angle A (°) | of equation (1) | ability | ability |
| 80 | 248 | 5 | 5 |
| 85 | 264 | 4 | 4 |
| 90 | 279 | 3 | 4 |
| 95 | 295 | 2 | 3 |

### Example 16

Evaluation was carried out as in Example 13, except that the peripheral speed of the printing evaluation apparatus was changed to 114 mm/sec. The evaluation results are shown in Table 16.

TABLE 16

| | | | 2-dot void fine |
|---|---|---|---|
| Contact | Value of left side | 1-dot formation | line formation |
| angle A (°) | of equation (1) | ability | ability |
| 80 | 254 | 4 | 5 |
| 85 | 269 | 4 | 4 |
| 90 | 285 | 3 | 3 |
| 95 | 301 | 2 | 3 |

From Tables 13 to 16, it can be seen that even if the thickness of the charge transport layer is increased to 30 μm, there are no problems with usage with a resolution of 1200 dpi if the contact angle is made to be 850 or less. Moreover, in the case of a resolution exceeding 1200 dpi as well, although not disclosed here, it was verified that according to the invention, usage is possible with no problems.

Summarizing the above, from Tables 1 to 16, it can be seen that under the condition of the invention that the value of the left side of equation (1) is less than 270, even if the thickness of the charge transport layer exceeds 25 μm, the evaluation level of the 1-dot formation ability can be made to be at least 4, with the evaluation level of the 2-dot void fine line formation ability maintained at at least 4. Hence, good images exhibiting a resolution of 1200 dpi can be obtained. Moreover, although printing wear resistance was not particularly measured in the tested items, with the invention, the thickness of the charge transport layer was made to exceed 25 μm. Therefore, it goes without saying that better printing wear resistance is obtained than in the case that the thickness of the charge transport layer is 25 μm or less. It can thus be seen that high printing wear resistance and a resolution of at least 1200 dpi both are attained.

According to the invention, in the case of an electrophotographic apparatus having a resolution of at least 1200 dpi that comprises a cylindrical electrophotographic photoreceptor having a charge generation layer and a charge transport layer, and electrophotographic processing components that are disposed in the vicinity of a peripheral surface of the photoreceptor, and forms images by operating the processing components while rotating the photoreceptor, the following relationships (1) and (2) among the peripheral speed V in mm/sec of the photoreceptor, the contact angle A in degrees of the surface of the photoreceptor to pure water, and the thickness T in μm of the charge transport layer of the photoreceptor are maintained:

V^{0.1}×A×T^{0.2}<270 (1)

T>25 (2)

As a result, an electrophotographic apparatus can be provided according to which images of high resolution of at least 1200 dpi can be obtained with high printing wear resistance even if a photoreceptor having a charge transport layer thickness exceeding 25 μm, is installed in the electrophotographic apparatus. This remarkable result is attained even though there is a strong tendency for the resolution to drop with such a large charge transport layer thickness.

This application corresponds to applicants' Japanese Patent Application Ser. No. 03-072122, filed Mar. 17, 2003, the entire disclosure of which is incorporated herein by reference.

What is claimed is:

1. An electrophotographic apparatus having a resolution of at least 1200 dpi that comprises a cylindrical electrophotographic photoreceptor having a charge generation layer and a charge transport layer, and electrophotographic processing components disposed in the vicinity of a peripheral surface of said photoreceptor, the apparatus forming images by operation of the processing components while rotating said photoreceptor;
wherein following relationships (1) and (2) hold among the peripheral speed V in mm/sec of said photoreceptor, the contact angle A in degrees of the surface of said photoreceptor to pure water, and the thickness T in μm of said charge transport layer of said photoreceptor.
V^{0.1}×A×T^{0.2}<270 (1)
T>25 (2).

2. The cylindrical electrophotographic photoreceptor for use as part of a electrophotographic apparatus, the apparatus having a resolution of at least 1200 dpi, the apparatus further including electrophotographic processing components disposed in the vicinity of a peripheral surface of the photoreceptor, the apparatus forming images by operation of the processing components while rotating said photoreceptor, the photoreceptor including
a charge generation layer, and
a charge transport layer,
wherein the following relationships (1) and (2) hold among the peripheral speed V in mm/sec of the photoreceptor, the contact angle A in degrees of the surface of said photoreceptor to pure water, and the thickness T in μm of said charge transport layer of said photoreceptor:
V^{0.1}×A×T^{0.2}<270 (1)
T>25 (2)
whereby images of high resolution can be obtained with high printing wear resistance even if the photoreceptor has a charge transport layer thickness exceeding 25 μm.
